(19) United States
(12) Patent Application Publication
(10) Pub. No.: US 2005/0056785 A1
(43) Pub. Date: Mar. 17, 2005

(54) Detection and analysis of chemical and biological materials by passive emission of terahertz wave against a cold background target

(75) Inventors: Mau-Song Chou, Rancho Palos Verdes, CA (US); Larry Yujiri, Redondo Beach, CA (US); David P. Dixon, Torrance, CA (US)

Correspondence Address: John A. Miller;Warn, Burgess & Hoffmann, P.C., P.O. Box 70098, Rochester Hills, MI, 48307, US

(73) Assignee: Northrop Grumman Corporation, Los Angeles, CA (US)

(21) Appl. No.: 10/663,310

(22) Filed: Sep. 16, 2003

(51) Int. Cl. G01J 5/00

(52) U.S. Cl. 250/338.1

(57) ABSTRACT

A system for detecting and analyzing chemical and biological materials in a sample. The system includes a spectrometer for passively receiving emissions from the sample in the terahertz frequency band to detect the materials therein. A telescope or other device can be used to confine the field-of-view of the spectrometer. A cold surface is positioned filling the field-of-view of the spectrometer at an opposite side of the sample from the spectrometer. The cold surface provides a low temperature background relative to the sample so as to reduce the background emission and enhance the detection of the emission from the sample.

### BACKGROUND OF THE INVENTION

1. Field of the Invention

This invention relates generally to a system and method for detecting materials in a sample and, more particularly, to a system and method for detecting chemical or biological materials in a sample by passive emission spectroscopy of the terahertz (THz) frequency band, where the background in the field-of-view of a spectrometer in the system is made very cold relative to the temperature of the sample.

2. Discussion of the Related Art

There is a need in the art for the rapid detection and analysis of biological materials, such as drugs, common cold, pollen, virus, bacteria and other toxins for public health purposes. Further, there is a need in the art for the non-invasive detection of chemical and biological materials that are concealed in a container, such as an envelope, cloth, plastic bottle or a glass container.

It is known in the art to detect certain constituents in a sample, such as a chemical or biological cloud in the air, by spectral analysis of the molecules in the sample. This type of detection has many applications, including detecting natural gas leaks from underground pipes, chemical clouds from chemical spills, volatile organic vapor from chemical processes, pollution from smokestacks, military chemical warfare agents, biological materials such as bacteria, explosives, illegal drugs, and other chemical or biological materials of interest. Some of these applications require detection sensitivity in the sub-ppb (parts per billion) level.

Sometimes this type of spectral analysis of a sample is performed remotely, such as up to several km away, because the constituents in the sample may be toxic, and thus a threat to health, or it may not be possible to directly detect the sample. The distance the detecting instrument has to be from the sample for remote passive sensing depends on the particular application, and different systems exist for different applications.

To perform this type of detection and analysis, a spectrometer, such as a Fourier transform infrared (FTIR) spectrometer, is directed towards the sample containing the material of interest, so that it passively receives emissions therefrom. Generally, the spectrometer detects emissions in the infrared wavelengths (5-25 μm). If the sample is warmer than the background, such as sky, mountains or other terrain, along the field-of-view of the spectrometer, target molecules in the sample will exhibit emissions having energy greater than the background emissions. If the sample is colder than the background, target molecules in the sample will exhibit absorption having energy less than the background emissions. If the sample is the same temperature as the background, the target molecules within the sample are absorbing photons at the same rate that they are emitting photons, so there is no discernable net emission from the sample. As the thermal contrast between the sample and the background increases, more net emissions are available to be received by the spectrometer.

A spectral display generated by the spectrometer from the emissions provides emission bands at certain wavelengths that are indicative of the molecules in the sample. Because each material has its own spectral “fingerprint” representative of its molecules, the detected spectral display can be compared to a known spectral fingerprint of a particular chemical or biological material of interest to determine if that material exists in the sample, and if so, at what level.

It has been suggested in the art that certain chemical and biological materials exhibit more unique spectral features from emissions in the terahertz frequency band. Thus, the materials may be easier to identify from emissions at this frequency band. However, most of the currently known spectroscopy methods that detect signals in these lower frequencies are based on absorption or transmission techniques. These techniques typically lack sufficient sensitivity to detect and analyze trace amounts of chemical and biological materials.

In the known absorption techniques, the sensitivity to detect certain constituents in the sample is limited by the system's ability to resolve the difference between the incident radiation and the transmitted radiation at the frequency fingerprint of the constituent. In other words, the detection sensitivity is determined by the system's ability to resolve a small absorption signal from a large incident radiation signal.

In those applications for the non-invasive detection of concealed chemical and biological materials, X-ray inspection methods currently available in the art to identify metallic objects cannot be used. It has been suggested in the art that spectral analysis in the terahertz frequency band through an absorption or transmission method can be employed to detect concealed biological and chemical materials through the use of an external radiation source. However, an absorption or transmission method for this purpose is likely to lack the necessary sensitivity. Further, an active radiation source may be either unavailable or relatively expensive. Furthermore, the use of such radiation in the open air may be harmful to humans.

U.S. Pat. No. 6,531,701, titled Remote Trace Gas Detection and Analysis, assigned to the Assignee of this application and herein incorporated by reference, discloses a system that employs a radiation beam to radiate a sample, such as a chemical cloud, to increase its temperature relative to the background. The wavelength of the radiation beam is selected to be in resonance with a particular target molecule in the cloud, or in resonance with water vapor or oxygen atoms commonly present in air. The resonance causes the target molecules, water vapor or oxygen molecules to rotate or vibrate, which causes their energy to increase. The radiation energy is thermalized due to collisional energy transfer causing inter-molecular relaxation. These factors increase the temperature of the cloud relative to the surrounding background that causes the emission intensity of the molecules in the cloud to increase resulting in improved detection. The emissions in the infrared wavelength are collected and analyzed by a spectrometer.

U.S. patent application Ser. No. 10/456,098, filed Jun. 6, 2003, titled “Detection and Analysis of Chemical and Biological Materials,” assigned to the assignee of this application and herein incorporated by reference, discloses a system and method for the detection and analysis of chemical and biological materials by spectral analysis of infrared emissions from a sample containing the materials. The '098 application employs a cold surface or device positioned opposite the sample from the spectrometer in the spectrometer's field-of-view to provide a cold background, and thus, a temperature differential between the background and the sample.

Currently, there is no suitable technique for the spectral analysis of particulate aerosols, bio-aerosols or liquid aerosols in situ in the air. Infrared absorption methods are typically ineffective because of the overwhelming interference from the light scattered by the aerosols. It may be desirable to extend the spectral analysis technique disclosed in the '098 application to a system that detects terahertz frequencies.

### SUMMARY OF THE INVENTION

In accordance with the teachings of the present invention, a system for detecting and analyzing chemical and biological materials in a sample is disclosed. The system includes a spectrometer, such as a Fourier transform spectrometer (FTS), for passively receiving emissions in the THz frequency band, ranging from approximately 0.1 to 10 THz, from the sample to detect the materials therein. A cold surface, provided by a liquid-helium dewar or a cryogenic cooler, is positioned within the field-of-view of the spectrometer at an opposite side of the sample from the spectrometer. The material for the cold surface preferably has high emissivity in the terahertz frequency band of interest. The cold surface provides a low temperature background relative to the temperature of the sample so as to increase the thermal contrast therebetween, and thereby enhance the detection of the emissions from the sample. Furthermore, the background emission received by the spectrometer is very low because of the presence of the cold surface. Hence, the emissions from the constituents in the sample can be precisely resolved by the spectrometer in the low or near absence of background emissions.

The sample can be in the form of an airborne sample in a cloud, a liquid or powder disbursed on a transparent window, or a sample concealed within a container. Further, the spectrometer can be replaced with a multi-frequency radiometer that down-converts the received emissions to an intermediate frequency (IF) over several frequency bands, each being detected by separate diode detector.

Additional advantages and features of the present invention will become apparent from the following description and appended claims, taken in conjunction with the accompanying drawings.

### BRIEF DESCRIPTION OF THE DRAWINGS

FIG. 1 is a graph with wave number on the horizontal axis and radiance on the vertical axis showing blackbody radiation curves at ambient temperature, 4K, 10K, 78K and 296K;

FIG. 2 is a plan view of a detection and analysis system for detecting chemical and/or biological materials in a sample cloud, where the system receives passive emissions in the THz frequency band and the system includes a cold device for providing a cold background relative to the sample, according to an embodiment of the present invention;

FIG. 3 is a plan view of a detection and analysis system for detecting chemical and/or biological materials in a sample placed on a transparent window, where the system receives passive emissions in the THz frequency band and the system includes a cold device for providing a cold background relative to the sample, according to another embodiment of the present invention;

FIG. 4 is a plan view of a detection and analysis system similar to the system shown in FIG. 3, but where the sample is concealed, according to another embodiment of the present invention;

FIG. 5 is a plan view of a detection and analysis system for detecting chemical and/or biological materials in a test compartment, where the system receives passive emissions in the THz frequency band and the system includes a cold device for providing a cold background relative to the sample, according to another embodiment of the present invention;

FIG. 6 is a plan view of a detection and analysis system for detecting chemical and biological materials, where the system splits received emissions into two channels to detect two frequency bands in the THz frequency band, according to another embodiment of the present invention; and

FIG. 7 is a plan view of a detection and analysis system for detecting chemical and biological materials deposited on a filter in a facility intake vent, where the system receives passive emissions in the THz frequency band and the system includes a cold device for providing a cold background relative to the sample, according to another embodiment of the present invention.

### DETAILED DESCRIPTION OF THE INVENTION

The following discussion of the embodiments of the invention directed to a system for detecting materials in a sample from passive emissions in the THz frequency band against a cold background is merely exemplary in nature, and is in no way intended to limit the invention or its application or uses.

As will be discussed in detail below, the detection and analysis systems of the invention detect passive emissions in the terahertz (THz) frequency band. This frequency band includes microwave, MMW and sub-MMW frequency bands, and includes the range of 1.0×10¹⁰-1.0×10¹³ cycles per second. The present invention is an extension of the '098 application that employs a cold background to provide a thermal contrast relative to the sample being detected. However, for emissions in the THz frequency band, the thermal contrast typically needs to be very high so that the emissions can be resolved at a proper speed.

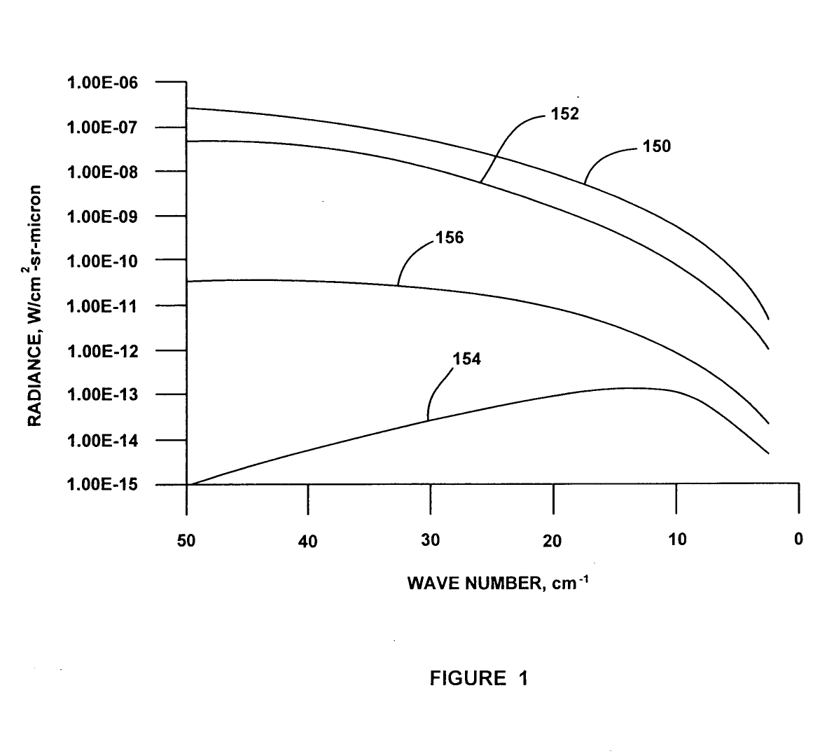

FIG. 1 is a graph with wave number on the horizontal axis and radiance on the vertical axis showing theoretical blackbody curves at ambient temperature of 296K, graph line 150, 78K (boiling point of liquid nitrogen), graph line 152, 4K (boiling point of liquid helium), graph line 154, and 10K (cryogenic cooler), graph line 156, based on Planck's function. These curves suggest that a cold temperature, such as 10K or below, is preferable to reduce the background emissions to a sufficiently low level for the frequency band of interest.

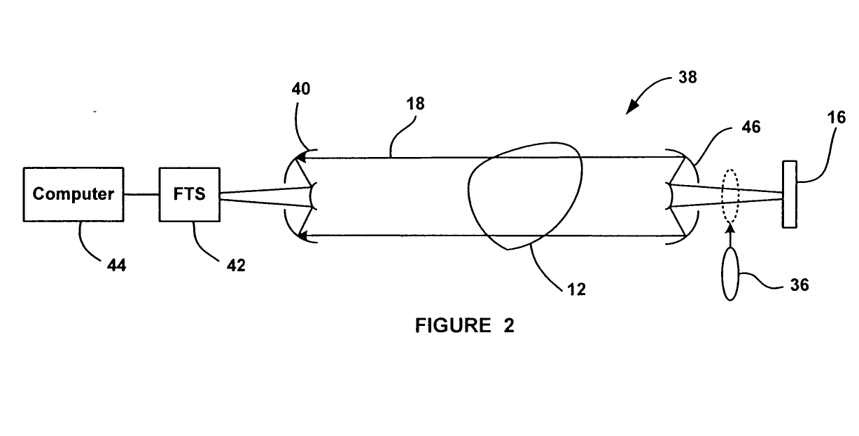

FIG. 2 is a plan view of a stand-off detection and analysis system 38 for detecting chemical and/or biological materials of interest in a cloud 12 in the air, according to an embodiment of the present invention. The chemical or biological materials in the cloud 12 can be in the form of vapors, liquid droplets and aerosols. A dish-type antenna 40 collects emissions 18 from the cloud 12. The antenna 40 focuses the emissions 18 onto the entrance aperture of a Fourier transform spectrometer (FTS) 42 operating tin the THz frequency band. As is known in the art, an FTS typically employs a special beam splitter, such as a Mylar element, and a cold detector, such as a silicon-bolometer, for detecting the spectral range of interest. One example of such a FTS is the Bruker Optics IFS 66V/S Vacuum FTIR spectrometer, known to those skilled in the art. The results of the spectral analysis from the FTS 42 can be analyzed and displayed on a computer 44. The emission spectrum provides identification of the chemical and/or biological materials in the cloud 12 based on characteristic molecular vibrational and rotational bands in the spectral range of interest.

According to the invention, a cold surface 16, cooled by a liquid helium dewar or a cryogenic cooler (not shown), is positioned at an opposite side of the cloud 12 from the FTS 42, as shown. The material for the surface 16 can be a terahertz absorber material that preferably has a high emissivity in the THz frequency band of interest. An example of such a material is an iron-loaded epoxy available from the Cuming Microwave Corporation. The cold surface 16 provides a low temperature background relative to the temperature of the cloud 12 so as to increase the thermal contrast therebetween, and thereby enhance the detection of the emissions 18 from the cloud 12. Furthermore, the background emission received by the FTS 42 is very low because of the presence of the cold surface 16. A Cassegrain-type collimator 46 positioned between the cold surface 16 and the cloud 12 for focusing the field-of-view of the antenna 40 to a smaller area so that a small cold surface relative to the size of the cloud 12 can be employed. A blackbody calibrator 36 is selectively positioned between the collimator 46 and the cold surface 16 to provide a room temperature calibration for comparison to the spectral signals.

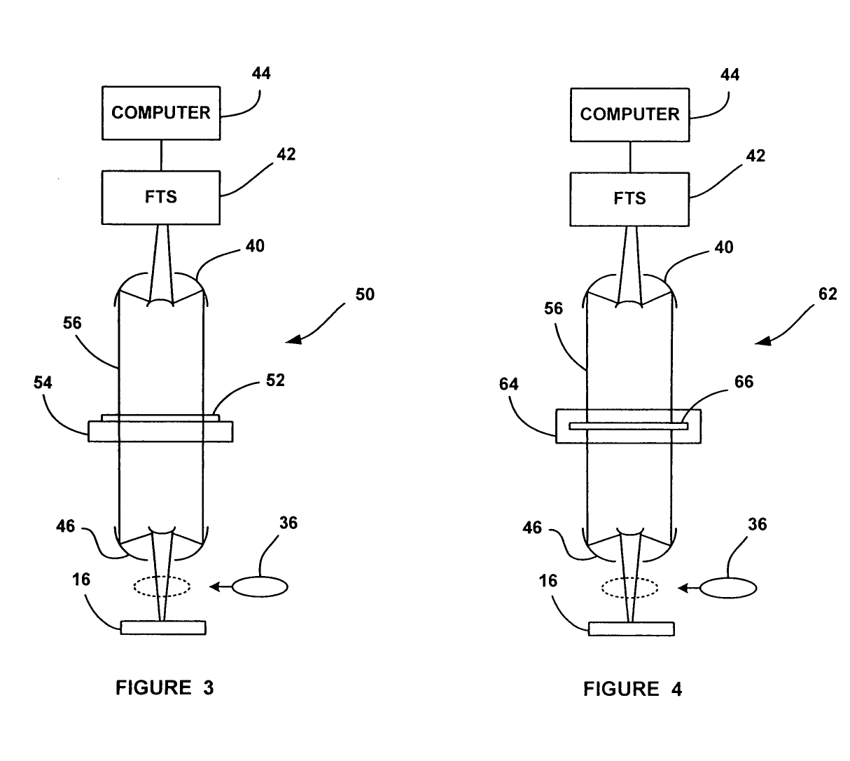

FIG. 3 is a plan view of a detection and analysis system 50 for detecting chemical and/or biological materials in a liquid or powder sample 52 placed on a substrate 54, according to another embodiment of the present invention. In this embodiment, like elements in the system 50 to the system 38 are identified by the same reference numeral. The system 50 also detects emissions 56 in the THz frequency band.

In one embodiment, the substrate 54 is a transmissive window. The window can be made of plastic ore an anti-reflective (AR) silicon window that has high transmission and low reflection in the terahertz frequency band. If a solid sample is not in the form of a fine powder, the sample 52 can be ground into a fine powder before being placed on the window 54. The size of the particles in the sample 52 should be less than the wavelength of interest to minimize any adverse effects of scattering.

In another embodiment, the substrate 54 is a filter. Airborne particulates, such as bio-aerosols can be collected on the filter by either sucking the air using a vacuum pump or by blowing the air using a fan. The filter material can be made of paper, plastic or fabric that have relatively good transmissive properties in the frequency band of interest. The emission spectrum from the sample 52 can be acquired by viewing through the filter against the cold surface 16.

FIG. 4 is a plan view of a detection and analysis system 62 that is similar to the detection and analysis system 50, where like reference numerals identify the same elements, according to another embodiment of the present invention. In this embodiment, the substrate 54 is replaced with a container 64, such as a letter envelope, cardboard container, plastic container or glass bottle, in which a chemical or biological sample 66 being detected is concealed. The system 62 provides a non-invasive detection of chemical and biological materials hidden within the container 64. It is known that these types of container materials have relatively high transmission in the terahertz frequency bands. The emission spectrum from concealed materials can be acquired by viewing through the container 64 against the cold surface 16. One potential application is the screening of anthrax powders in letters in a mail distribution center. Another example is the detection of explosives in a plastic bag and the detection of illicit drugs or chemical and biological agents in cardboard, plastic or glass containers.

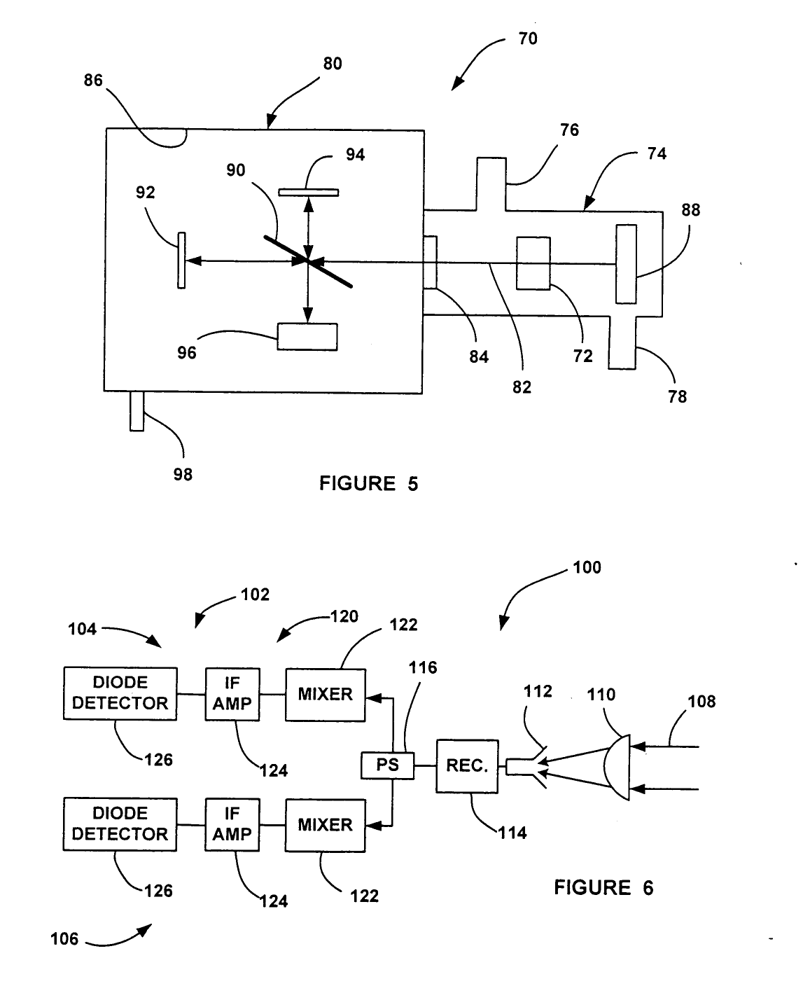

FIG. 5 is a plan view of a detection and analysis system 70 for detecting a chemical and/or biological sample 72 confined within a sample compartment 74, according to another embodiment of the present invention. In this embodiment, the sample 72 is placed on a transmissive window or confined in a sample holder. Alternately, the sample 72 can be in the form of a vapor or aerosol dispersed within the compartment 74. The compartment 74 can be purged with a nitrogen gas or can be evacuated by a vacuum pump through openings 76 and 78. This minimizes the interference caused by water vapor and/or oxygen in the air. In one embodiment, the compartment 74 is a glass chamber, but can be any chamber suitable for the purposes discussed herein.

An FTS 80, including a detection chamber 86, is positioned adjacent to the sample compartment 74. Passive emissions 82 from the sample 72 are transmitted through a window 84 in the compartment 74 into the detection chamber 86 of the FTS 80. The window 84 has a high transmission and low reflectance for the passive emissions 82 at the frequency band of interest. According to the invention, a cold surface 88 fills the field-of-view of the FTS 80 within the compartment 74 at an opposite side of the sample 72. As discussed above, the cold surface 88 can be cooled by liquid helium or by a cryogenic cooler to provide the necessary thermal contrast for detecting the emissions 82 in the THz frequency band.

The FTS 80 can be any FTS suitable for the purposes described herein. In one embodiment, the FTS 80 is the Model No. IFS 66 V/S vacuum FTIR spectrometer system available from Bruker Optics. In this embodiment, the FTS 80 includes a beam splitter 90 that splits the emissions 82 into a first beam directed towards a movable mirror 92 and a second beam directed towards a fixed mirror 94. The beams reflected by the mirrors 92 and 94 are directed back towards the beam splitter 90 that combines the beams to impinge on a detector 96. The detector 96 can be any detector suitable for the purposes described herein, such as a liquid-helium cooled silicon bolometer. By scanning the mirror 92, an interference pattern can be generated on the detector 96 to detect the frequency band of interest. The chamber 86 can be evacuated through a port 98 by a vacuum pump (not shown) so that air within the chamber 86 does not interfere with the detection process.

FIG. 6 is a plan view of a detection and analysis system 100 that includes a receiver 102 having two separate channels 104 and 106. FIG. 6 does not show the sample and the cold surface of the system 100, but these elements are included in the system 100 consistent with the discussion above. Emissions 108 are focused by a lens 110 onto a feedhorn antenna 112 and are received by a receiver 114 where they are amplified. The amplified signal is split by a power splitter 116 so that the split signals are directed into the two channels 104 and 106. Each channel 104 and 106 includes a radiometer 120 having a mixer 122, an IF amplifier 124 and a diode detector 126. The signal received by the receiver 114 is applied to the mixer 122 in each of the channels 104 and 106 for down-converting the signal to an intermediate frequency (IF) signal suitable to be processed by the radiometer 120. The down-converted signal is amplified by the IF amplifier 124, and the amplified IF signal is sent to the diode detector 126. The diode detector 126 provides a voltage representation of the signal indicative of the frequencies received from the emissions 108. The voltage signal is then sent to an analyzing device (not shown) to resolve the emissions spectrum of the emissions 108. The emissions spectrum provides identification of the chemical and/or biological materials in the sample being detected based on characteristic molecular vibrational and rotational bands in the spectral range of interest.

By splitting the emissions 108 into two signal paths, the mixers 122 and the IF amplifiers 124 can be tuned to different frequency bands to provide added sensitivity for a narrower frequency band within the THz frequency band. In alternate embodiments, the power splitter 116 can split the signal into any suitable number of signal channels for separate signal detection. These separate frequency bands can be selected to permit unique identification of chemical or biological agents through the detection of signal strength in the selected bands.

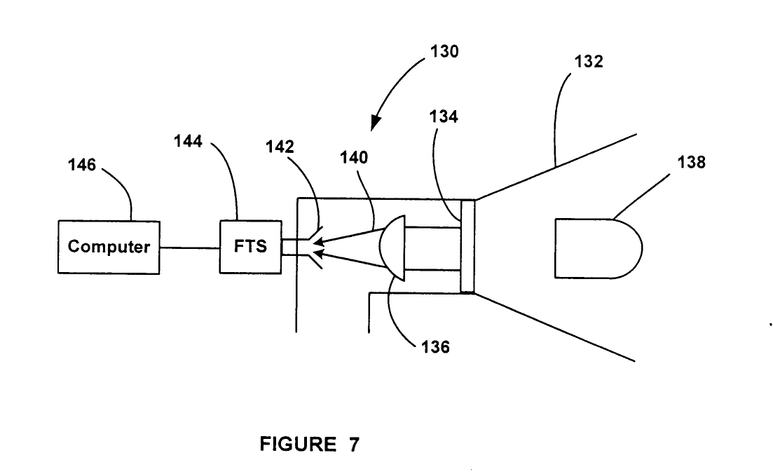

FIG. 7 is a plan view of a detection and analysis system 130, according to another embodiment of the present invention. In this embodiment, the detection system 130 is used to monitor the airflow into a facility, such as a commercial building. Air is forced through a vent 132 by a suitable fan or the like (not shown) so that air flows through a filter 134. Particulates and other materials in the airflow will collect on the filter 134 where they can be detected. A lens 136 is positioned on one side of the filter 134 and a cryo-cooler 138 is positioned on an opposite side of the filter 134. Passive emissions 140 from the filter 134 are focused by the lens 136 onto the entrance aperture 142 of an FTS 144 where the emissions 140 are analyzed. A computer 146 displays the spectrum.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A system for detecting and analyzing chemical and biological materials in a sample, said system comprising:
a detection device responsive to passive emissions from the sample, said emissions being in the terahertz frequency band, said detection device having a field-of-view and generating an emission spectrum of materials in the sample; and
a cold surface positioned in the field-of-view of the detection device, said cold surface providing a cold background relative to the temperature of the sample.

2. The system according to claim 1 wherein the cold surface includes a terahertz absorber cooled by the group consisting of liquid-helium dewars and cryogenic coolers.

3. The system according to claim 1 wherein the detection device is a Fourier transform spectrometer providing a spectrum analysis of the emissions.

4. The system according to claim 1 further comprising a sample compartment, said sample being confined within the compartment.

5. The system according to claim 1 wherein the sample is within an airborne cloud.

6. The system according to claim 1 further comprising a transmissive substrate, said sample being placed on the transmissive substrate.

7. The system according to claim 6 wherein the transmissive substrate is a plastic window or an anti-reflective coated silicon window.

8. The system according to claim 1 further comprising a filter, said sample being in the filter.

9. The system according to claim 8 wherein the filter is positioned within an air intake vent of a facility.

10. The system according to claim 1 further comprising a container, said sample being contained in the container.

11. The system according to claim 10 wherein the container is selected from the group consisting of an envelope, a cardboard enclosure, a plastic container and a glass container.

12. The system according to claim 1 further comprising an antenna, said antenna collecting the emissions and directing the emissions to the detection device.

13. The system according to claim 12 wherein the antenna is selected from the group consisting of a feed horn and a Cassegrain-type telescope.

14. The system according to claim 1 further comprising a collimator, said collimator focusing the field-of-view of the detection device onto the cold surface.

15. The system according to claim 14 wherein the collimator is a Cassegrain-type telescope.

16. The system according to claim 1 wherein the detection device includes a power splitter and a plurality of detection channels, said power splitter receiving the emissions and directing the emissions into the plurality of channels so that multiple frequency bands can be simultaneously detected.

17. The system according to claim 1 wherein the detection device includes a terahertz receiver for receiving and amplifying signals in the terahertz frequency band.

18. The system according to claim 1 wherein the terahertz frequency band includes microwave, millimeter wave and sub-millimeter wave frequency bands.

19. The system according to claim 1 wherein the sample is selected from the group consisting of a liquid sample, a powder sample, a liquid aerosol sample, a particulate aerosol sample, a bio-aerosol sample, a vapor sample, a gas sample, chemical agents, biological agents, industrial chemicals, toxins, drugs, fungi, pollens, and explosives in the form of vapor, powder, liquid or aerosol.

20. A system for stand-off detecting and analyzing materials in a sample cloud in the air, said system comprising:
a detection device responsive to passive emissions from the sample cloud, said emissions being in the terahertz frequency band, said detection device having a field-of-view and generating an emission spectrum of the materials in the sample cloud; and
a cold surface positioned in the field-of-view of the detection device, said cold surface providing a cold background relative to the temperature of the sample cloud.

21. The system according to claim 20 wherein the cold surface is made of a terahertz absorber cooled by the group consisting of liquid-helium dewars and cryogenic coolers.

22. The system according to claim 20 wherein the detection device is a Fourier transform spectrometer providing a spectrum analysis of the emissions.

23. The system according to claim 20 further comprising a collimator, said collimator focusing the field-of-view of the detection device onto the cold surface.

24. The system according to claim 20 wherein the terahertz frequency band includes microwave, millimeter wave and sub-millimeter wave frequency bands.

25. The system according to claim 20 wherein the sample is selected from the group consisting of a liquid sample, a powder sample, a liquid aerosol sample, a particulate aerosol sample, a bio-aerosol sample, a vapor sample, a gas sample, chemical agents, biological agents, industrial chemicals, toxins, drugs, fungi, pollens, and explosives in the form of vapor, powder, liquid or aerosol.

26. A system for detecting and analyzing chemical and biological materials in a sample, said system comprising:
a compartment for holding the sample, said compartment including a transmission window;
a detection device responsive to passive emissions from the sample transmitted through the transmission window, said emissions being in the terahertz frequency band, said detection device generating an emission spectrum of the materials in the sample; and
a cold surface positioned in the compartment at an opposite side from the detection device, said cold surface providing a cold background relative to the temperature of the sample.

27. The system according to claim 26 wherein the cold surface is made of a terahertz absorber cooled by the group consisting of liquid-helium dewars and cryogenic coolers.

28. The system according to claim 26 wherein the detection device is a Fourier transform spectrometer providing a spectrum analysis of the emissions.

29. The system according to claim 26 further comprising a collimator, said collimator focusing a field-of-view of the detection device onto the cold surface.

30. The system according to claim 26 wherein the terahertz frequency band includes microwave, millimeter wave and sub-millimeter wave frequency bands.

31. The system according to claim 26 wherein the sample is selected from the group consisting of a liquid sample, a powder sample, a liquid aerosol sample, a particulate aerosol sample, a bio-aerosol sample, a vapor sample, a gas sample, chemical agents, biological agents, industrial chemicals, toxins, drugs, fungi, pollens, and explosives in the form of vapor, powder, liquid or aerosol.

32. A system for detecting and analyzing chemical and biological materials in a sample, said system comprising:
a transmission window, said sample being deposited on a surface of the transmission window;
a detection device responsive to passive emissions from the sample, said emissions being in the terahertz frequency band, said detection device having a field-of-view and generating an emission spectrum of the materials in the sample; and
a cold surface positioned in the field-of-view of the detection device, said cold surface providing a cold background relative to the temperature of the sample.

33. The system according to claim 32 wherein the cold surface is made of a terahertz absorber cooled by the group consisting of liquid-helium dewars and cryogenic coolers.

34. The system according to claim 32 wherein the detection device is a Fourier transform spectrometer providing a spectrum analysis of the emissions.

35. The system according to claim 32 further comprising a collimator, said collimator focusing the field-of-view of the detection device onto the cold surface.

36. The system according to claim 32 wherein the terahertz frequency band includes microwave, millimeter wave and sub-millimeter wave frequency bands.

37. The system according to claim 32 wherein the sample is selected from the group consisting of a liquid sample, a powder sample, a liquid aerosol sample, a particulate aerosol sample, a bio-aerosol sample, a vapor sample, a gas sample, chemical agents, biological agents, industrial chemicals, toxins, drugs, fungi, pollens, and explosives in the form of vapor, powder, liquid or aerosol.

38. A system for detecting and analyzing chemical and biological materials in a sample, said system comprising:
a container, said sample being contained in the container;
a detection device responsive to passive emissions from the sample, said emissions being in the terahertz frequency band, said detection device having a field-of-view and generating an emission spectrum of the materials in the sample; and
a cold surface positioned in the field-of-view of the detection device, said cold surface providing a cold background relative to the temperature of the sample.

39. The system according to claim 38 wherein the container is selected from the group consisting of an envelope, a cardboard enclosure, a plastic container and a glass container.

40. The system according to claim 38 wherein the cold surface is made of a terahertz absorber cooled by the group consisting of liquid-helium dewars and cryogenic coolers.

41. The system according to claim 38 wherein the detection device is a Fourier transform spectrometer providing a spectrum analysis of the emissions.

42. The system according to claim 38 further comprising a collimator, said collimator focusing the field-of-view of the detection device onto the cold surface.

43. The system according to claim 38 wherein the terahertz frequency band includes microwave, millimeter wave and sub-millimeter wave frequency bands.

44. The system according to claim 38 wherein the sample is selected from the group consisting of a liquid sample, a powder sample, a liquid aerosol sample, a particulate aerosol sample, a bio-aerosol sample, a vapor sample, a gas sample, chemical agents, biological agents, industrial chemicals, toxins, drugs, fungi, pollens, and explosives in the form of vapor, powder, liquid or aerosol.

45. A system for detecting and analyzing chemical and biological materials in a sample, said system comprising:
a detection device responsive to passive emissions from the sample, said emissions being in the terahertz frequency band, said detection device having a field-of-view and generating an emission spectrum of the materials in the sample, said detection device including a power splitter and a plurality of detection channels, said power splitter receiving the emissions and directing the emissions into the plurality of channels so that multiple frequency bands can be simultaneously detected; and
a cold surface positioned in the field-of-view of the detection device, said cold surface providing a cold background relative to the temperature of the sample.

46. The system according to claim 45 wherein the cold surface is made of a terahertz absorber cooled by the group consisting of liquid-helium dewars and cryogenic coolers.

47. The system according to claim 45 wherein the detection device includes a radiometer in each channel.

48 The system according to claim 45 wherein each radiometer includes a mixer for down-converting the emissions, an intermediate frequency amplifier for amplifying the down-converted emissions and a diode detector for detecting the amplified and down-converted emissions.

49. The system according to claim 45 further comprising a collimator, said collimator focusing the field-of-view of the detection device onto the cold surface.

50. The system according to claim 45 wherein the terahertz frequency band includes microwave, millimeter wave and sub-millimeter wave frequency bands.

51. The system according to claim 45 wherein the sample is selected from the group consisting of a liquid sample, a powder sample, a liquid aerosol sample, a particulate aerosol sample, a bio-aerosol sample, a vapor sample, a gas sample, chemical agents, biological agents, industrial chemicals, toxins, drugs, fungi, pollens, and explosives in the form of vapor, powder, liquid or aerosol.

52. A system for detecting and analyzing chemical and biological materials in air flowing through an air intake vent of a building, said system comprising:
a filter positioned in the air intake vent where the air flows through the filter so that particles in the air are captured by the filter;
a detection device positioned at one side of the filter and being responsive to passive emissions from the filter, said detection device generating an emission spectrum of materials in the filter; and
a cold surface positioned at an opposite side of the filter from the detection device, said cold surface providing a cold background relative to the temperature of the filter.

53. The system according to claim 52 wherein the cold surface is made of a terahertz absorber cooled by the group consisting of liquid-helium dewars and cryogenic coolers.

54. The system according to claim 52 wherein the detection device is a Fourier transform spectrometer providing a spectrum analysis of the emissions.

55. The system according to claim 52 further comprising a collimator, said collimator focusing the field-of-view of the detection device onto the cold surface.

56. The system according to claim 52 wherein the emissions are in the terahertz frequency band.

57. The system according to claim 52 wherein the sample is selected from the group consisting of a liquid sample, a powder sample, a liquid aerosol sample, a particulate aerosol sample, a bio-aerosol sample, a vapor sample, a gas sample, chemical agents, biological agents, industrial chemicals, toxins, drugs, fungi, pollens, and explosives in the form of vapor, powder, liquid or aerosol.

58. A method for detecting and analyzing chemical and/or biological materials in a sample, said method comprising:
receiving emissions from the sample in a field-of-view of a spectrometer, said emissions being in the terahertz frequency band;
generating an emission spectrum of the materials in the sample in the field-of-view of the spectrometer; and
cooling the background of the sample in the field-of-view of the spectrometer relative to the temperature of the sample.

59. The method according to claim 58 wherein the sample is confined in a sample compartment, concealed in a container, airborne, captured in a filter or placed on a transmissive substrate.

60. The method according to claim 58 wherein the detection device is selected from the group consisting of a Fourier transform spectrometer or a radiometer.

61. The method according to claim 58 wherein the cold surface is made of terahertz absorber cooled by the group consisting of liquid-helium dewars and cryogenic coolers.

62. The method according to claim 58 further comprising focusing the field-of-view of the spectrometer onto the cold surface.

63. The method according to claim 58 further comprising splitting the emissions into a plurality of detection channels for detecting a plurality of frequency bands.

64. The method according to claim 58 wherein the terahertz frequency band includes microwave, millimeter wave and sub-millimeter wave frequency bands.

65. The method according to claim 58 wherein the sample is selected from the group consisting of a liquid sample, a powder sample, an aerosol sample, a vapor sample, a gas sample, chemical agents, biological agents, industrial chemicals, toxins, drugs, fungi, pollens and explosives.
